(19) United States
(12) Patent Application Publication
(10) Pub. No.: US 2013/0042197 A1
(43) Pub. Date: Feb. 14, 2013

(54) CHEMISTRY AND PHYSICS CALCULATOR

(71) Applicant: Daniel Amare, Brentwood, CA (US)

(72) Inventor: Daniel Amare, Brentwood, CA (US)

(21) Appl. No.: 13/399,997

(22) Filed: Feb. 17, 2012

Related U.S. Application Data
(60) Provisional application No. 61/523,046, filed on Aug. 12, 2011.

(51) Int. Cl. G06F 3/048

(52) U.S. Cl. 715/777; 715/841; 715/808

(57) ABSTRACT

Disclosed herein is a chemistry and physics calculator for helping a user to solve chemistry and physics problems. The calculator does more than calculating numbers or solving equations; rather, the calculator includes an adaptable menu and sub-menu system that helps a user analyze a problem, determine the type of the problem, and helps a user choose equations that are needed to solve the problem. The calculator includes at least some of these topics: balancing equations, stoichiometry, gas laws, equilibrium, dimension analysis, electrochemistry, electricity, Newton laws, thermodynamics, properties of matter, mirrors and lenses, Ohm's law, and Kirchhoff's Law. Additionally, the calculator prompts users to input units for variables, performs unit analysis, and displays results with units. The invention can be implemented as a handheld calculator, as a computer program, or as a program for a handheld device such as a smart phone.

### CROSS REFERENCE TO RELATED APPLICATIONS

This application claims the benefit of priority of U.S. Provisional Patent Application No. 61/523,046 filed 12 Aug. 2011, which is incorporated herein by reference in its entirety.

### FIELD OF THE DISCLOSURE

This invention relates to calculators, computer implemented methods and programs that help a user to solve chemistry and physics problems.

### BACKGROUND OF THE INVENTION

Students, technicians and research and development personnel often have difficulty solving chemistry and physics problems using a general graphic calculator or other related software. This is because unit analysis or dimension analysis is not used in these software programs like the one disclosed here.

Chemistry and physics students will enhance their learning by using a calculator that allows entering units and displays the answer with the correct units. Unit conversion and cancelations can be seen on the screen for the user.

The problem with the prior art is that most software programs used in the chemical calculations have limited capabilities, in that, one enters the necessary data in a window without units and the answer is displayed without unit analysis also. The prior art is mostly used with a personal computer to solve these calculations. The prior art does not display the answer to a chemistry or physics problem with units. The prior art for stoichiometry calculations is only limited to stoichiometry problem solving only that displays answers without the units. The prior art is neither applied nor capable for application to a general hand-held calculators that are used in the classroom.

To avoid this inconvenience, a chemistry and physics hand-held calculator with unit analysis according to the present invention can readily be available with unit analysis in a calculator, a computer or a hand-held device. This can be achieved right in the classroom discussions between students and teachers, and for solving chemistry and physics problems during exams and quizzes.

### SUMMARY OF THE INVENTION

One problem faced with solving a chemistry or physics problem using a calculator is that crunching numbers is often only the last step in a multiple-step process. The first steps in solving a chemistry problem are usually to find out what mathematical equation (s) should be used. For example, to solve a gas law problem, a user must first recognize that the chemistry problem is a gas law problem rather than an electrochemistry problem, stoichiometry or a chemical equilibrium problem. Having recognized that the problem is a gas law problem, the user must still be able to pick an equation from several equations among PV=nRT and its variants including “1: V₁/T₁=V₂/T₂,” “2: P₁/V₁=P₂/V₂,” “3: P₁V₁/T₁=P₂V₂/T₂,” and “4: V₁/n₁=V₂/n₂”. A general calculator or graphing calculator is not helpful in this regard because it is not equipped with any specialized chemical or physical information.

In various embodiments of the present invention, the first objective is to design a succinct menu system that help a user determine what type a problem it is, and what equations should be used to solve the problem. In certain embodiments, the task is especially challenging because of the limitations in a handheld calculator that has a small screen, limited memory and computing power, and limited input/output interface. Thus, the chemistry or physics calculator will not attempt to solve a chemistry or physics problem for a user entirely automatically. Instead, the calculator provides a guide, implemented in a menu-submenu system, that a user can follow to reduce a complicated chemistry or physics problem to a series of multiple choices, and eventually to one or more equations that solves the problem. Although the calculator provides some guidance and proof-check, the user ultimately has to make choices based on his/her own learning. Thus, the calculator is a facilitator in some sense.

Another challenge for solving chemistry or physics problem is that correct units must be used even after the right equation is selected. Take a simple example in gas law, that the volume of a given amount of gas at constant pressure is proportional to temperature, expressed in the equation V₁/T₁=V₂/T₂. The correct unit for this equation is Kelvin, not Centigrade or Fahrenheit. For example, a volume of gas does not occupy twice as much volume at 30° C. compared to 15° C. The correct volume ratio is (273+30)K/(273+15)K. A general calculator is incapable of detecting this kind of error because it does not require the entry of units, nor it is capable of checking the correctness of the units.

Thus, another objective of the invention is to provide chemistry and physics calculating devices with capabilities of unit analysis. In various embodiments, the chemistry calculator requires the entry of units when a user enters values for known variables. The calculator will check the validity of the units entered. In addition, the calculator will display calculation process and answers with the correct units.

In other embodiments, the calculator is not limited to calculating chemical elements or atomic mass and molecular weight of a compound. The periodic table may be stored in the calculator and be displayed on the screen at a user's command. The element of interest will then be selected and the physical and chemical properties of the element will be displayed, which can also be used for further calculations of molecular weights, atomic weights, stoichiometry problems, mole problems, equilibrium problems and calculations with units.

According to one embodiment, a calculator includes a display, an input means, a memory including program code and a database, which database includes common topics, equations, and constants in chemistry and physics, and a processor coupled to the display, memory, and input means. The processor is capable of executing the program code for the calculator to perform a method to solve chemistry or physics problems. The method includes the following steps: displaying a list of topics, said topics including one or more chemistry topics or physics topics; accepting a user topic selection; displaying a list of one or more equations related to said user topic selection, each of said equations including more than one variables; accepting a user selection of an equation from said list of equations; optionally accepting a user designation of one or more unknown variables for said user selection of an equation; accepting user input of one or more values, and units where applicable, for one or more known variables for said user selection of an equation; calculating one or more values, and units where applicable, of said one or more unknown variables; displaying said values of one or more unknown variables, with units where applicable.

In another embodiment, a computer implemented method for solving chemistry and physics problems includes the following steps: displaying a list of topics, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density; accepting a user topic selection; displaying a list of one or more equations related to said user topic selection, each of said equations including more than one variables; accepting a user selection of a user selected equation from said list of equations; optionally accepting a user designation of one or more unknown variables for said user selected equation; accepting user input of one or more values, and units where applicable, for one or more known variables for said user selected equation; and displaying said values, and units where applicable, of one or more unknown variables.

In yet another embodiment, one or more non-transitory computer readable media have processor readable program code embodied on at least one of said non-transitory computer readable media, said program code programming at least one processor to perform a method of chemistry and physics calculation, including the following steps: displaying a list of topics, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density; accepting a user topic selection; displaying a list of one or more equations related to said user topic selection, each of said equations including more than one variables; accepting a user selection of a user selected equation from said list of equations; optionally accepting a user designation of one or more unknown variables for said user selected equation; accepting user input of one or more values, and units where applicable, for one or more known variables for said user selected equation; calculating values, and units where applicable, of said one or more unknown variables; and displaying said values, and units where applicable, of one or more unknown variables. Here, the program code may be all written on one computer readable medium on a computer local to a user, on an optical disc, on a flash drive, or on a magnetic disk drive. Alternatively, the program code may be distributed among more than one storage media. The program code may also be stored on one or more remote storage media and be sent to a user computing device via a network.

### BRIEF DESCRIPTION OF THE DRAWINGS

FIG. 1 is a block diagram of a calculator.

FIG. 2 is a flow chart of a computer implemented method for solving chemistry and physics problems.

FIG. 3 is a flow chart of a method programmed by a program code embodied on one or more non-transitory computer readable media.

FIGS. 4-1 to 4-7 are screen diagrams of a calculator solving a gas law problem.

FIGS. 5-1 to 5-11 are screen diagrams of a calculator solving a stoichiometry problem.

FIG. 6 is a plot or reaction rate vs. time displayed by a calculator.

FIG. 7 is a plot of concentration vs. time displayed by a calculator.

FIG. 8 is a periodic table displayed by a calculator.

FIGS. 9-1 to 9-9 are screen diagrams of a calculator solving a molarity problem.

FIGS. 10-1 to 10-5 are screen diagrams of a calculator solving a Newton law problem.

FIGS. 11-1 to 11-11 are screen diagrams of a calculator performing a density calculation.

### DETAILED DESCRIPTION OF THE INVENTION

Various embodiments of the present invention provide the use of a hand-held calculator programmed to teach chemistry and physics in a manner to use unit analysis. It can also be used in a computer, iPads and iPhones. Some, but not all, embodiments of the invention are shown. This invention may be embodied in many different forms and should not be construed as limited to the embodiments set forth herein. Even though many embodiments described herein refer to a handheld calculator, it will be understood that the chemistry and physics calculator can be embodied as a special purpose calculator, an application program for a calculator, an application program for a handheld device, an application program for a computer, or a web application that can be accessed remotely through a special application program or through a general browser such as Internet Explorer or Firefox.

One skilled in the art will appreciate that the present invention may be embodied as a method, a handheld device, a computer program, or a program for a smart device such as iPhone, programmable calculator, etc. Accordingly, the present invention may take the form of an entirely hardware embodiment, an entirely software embodiment, or an embodiment combining software and hardware aspects. Further, the present invention may take the form of a computer or calculator program product on a computer-readable storage medium having computer-readable program instructions (e.g., computer software) embodied in the storage medium. Any suitable computer-readable storage medium may be utilized including hard disks, flash memories, and CD-ROMs. The present invention may be implemented as a web-implemented computer software, for example, a virtual calculator delivered on the web that solves chemistry and physics problems.

The present invention is described with reference to screen shots, block diagrams, and flowchart illustrations of methods, apparatuses, and computer program products according to various embodiments of the invention. A person of ordinary skill in the art will appreciate that the each block of the block diagrams and flowchart, and combinations of blocks in the block diagrams and flowchart illustrations, respectively, can be implemented by computer or calculator program instructions. The computer or calculator program instructions may be written in various programming languages for various computer platforms such as various calculators, mobile device platforms such as iOS and Android, Windows, Macintosh, and Linux. The computer or calculator program instructions may be loaded onto a general purpose computer, a special purpose computer, a calculator, a handheld device such as a smart phone, or other programmable data processing apparatus to produce a machine, such that the instructions which execute on the computer or other programmable data processing apparatus to create a means for implementing the functions specified in the flow-chart block or blocks.

The computer or calculator program instructions may also be stored in a computer or calculator readable memory that can direct a computer, calculator, or other programmable data processing apparatus to function in a particular manner, such that the instructions stored in the computer or calculator readable memory produce an article of manufacture including computer or calculator-readable instructions for implementing the functions specified in the flowchart block or blocks. The computer or calculator program instructions may also be loaded onto a computer or other programmable data processing apparatus to cause a series of operational steps to be performed on the computer or other programmable apparatus to produce a computer or calculator-implemented process such that the instructions that execute on the computer or other programmable apparatus provide steps for implementing the functions specified in the flowchart block or blocks.

It will be understood that each block of the block diagrams and flowchart illustrations, and combinations of blocks in the block diagrams and flowchart illustrations, can be implemented by special purpose hardware-based computer or calculator apparatus that perform the specified functions or steps, or combinations of special purpose hardware and computer instructions. Various embodiments also describe hardware components and functions such as a button or pressing a button. It will be understood that a button may be an actual button on a device such as a calculator button, a keyboard key, or a button or link on a computer screen that can be clicked on or touched upon.

The chemistry and physics calculator solves chemistry and physics problems at a college level and operates by displaying unit analysis or providing the answer to the problem with the right units. Various embodiments of this invention have also the features of a graphing calculator, in addition to the chemistry and physics calculations capability. For example, if the chemistry problem to be solved deals with gas laws, one may press the proper key in the calculator keyboard which displays all the gas law equations on the screen. One then would select the proper equation, enter the known variables or data with the proper unit, and the calculator will provide the answer with the correct unit.

For example if one is dealing with chemical equilibrium problem solving, one would use the equilibrium equation that is stored in the program, for example:

Kₐ=[B]²[C]/[A]³, which is written for the chemical equation: 3A→2B+C

The chemical equations may or may not be balanced by the user. The calculator may have a capability of giving equations to be balanced when necessary.

In various embodiments, the equilibrium constant, Kₐ or K_{b}, for many chemical equations are stored in the computer, can then be easily accessed by pressing a key on the keyboard where one would select the necessary equilibrium constant from a list of equilibrium constant values for a particular chemical equation. In a similar fashion other constants such as ΔH_{f}, ΔG_{f}, the periodic table, and other chemistry and physics constants including physical and chemical constants are stored in the program and displayed on the screen when pressing the proper key.

In stoichiometry type problems, one can select an appropriate key to generate a list of chemical equations, select the needed ones from the list of equations and balance the equation. Molecular weights, atomic weights can be found from a periodic table stored in the calculator, computer or iPad. A user may press a key to display the periodic table on the screen, select the element needed with the proper unit to use in stoichiometry related problem solving.

The chemistry calculator may include many topics of chemistry and physics problem solving that includes pH calculations, equilibrium calculations, Newton law calculations, velocity and acceleration calculations, gas law calculations and more. Ideally, the calculator according to the present invention should be able to solve substantially all types of problems in college chemistry and physics problems in general chemistry and general physics courses.

This electronic calculator may be similar to the ones used by many chemistry and physics students such as the TI graphic calculator except that it has the additional feature of computing chemistry and physics problems with unit or dimension analysis. The student, lab technician, R&D personnel can perform physics and chemistry problem calculations with unit entry for variables and unit display for the answers.

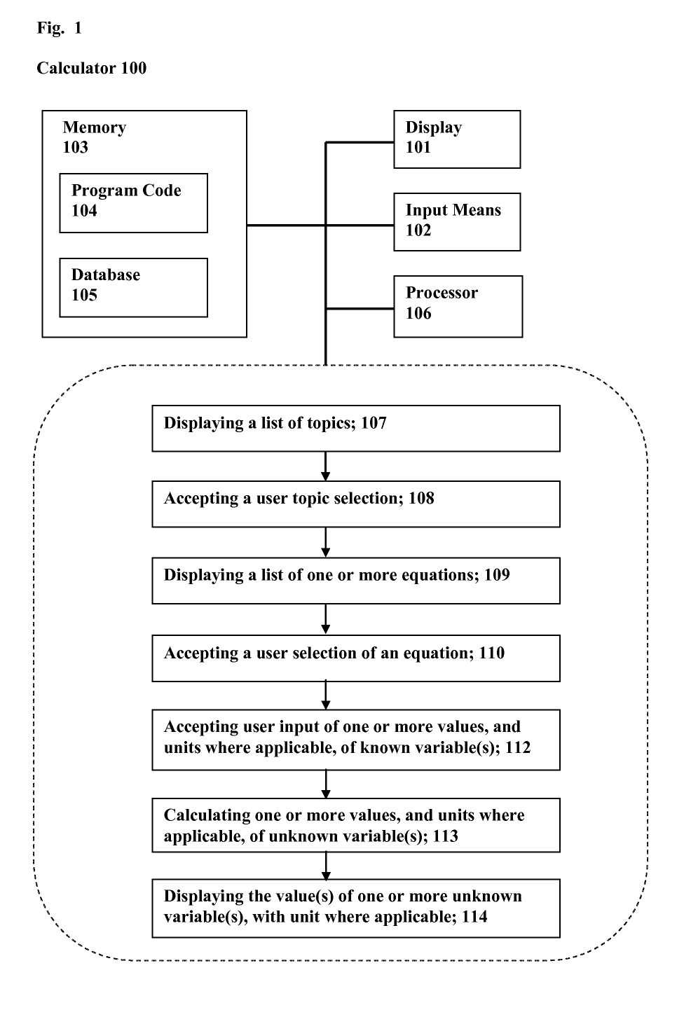

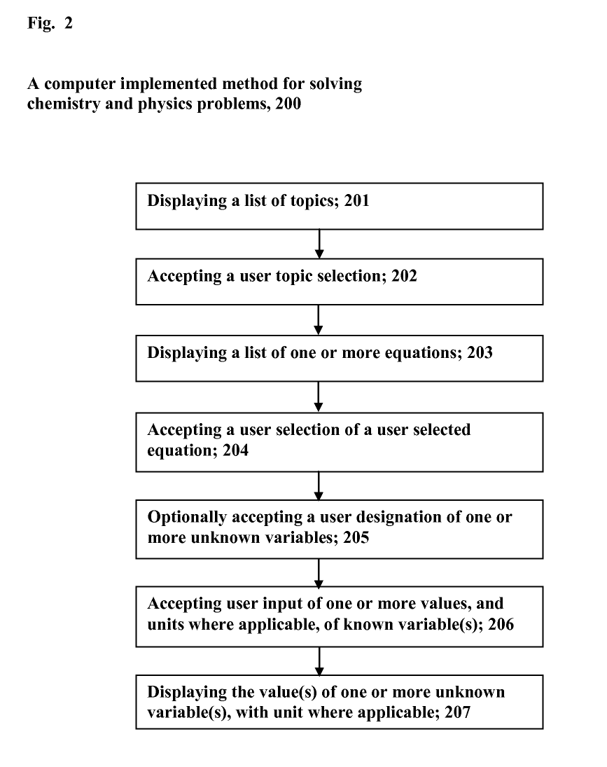

According to one embodiment as shown in FIG. 1, a calculator 100 includes a display 101, an input means 102, a memory 103 including program code 104 and a database 105, which database includes common topics, equations, and constants in chemistry and physics, and a processor 106 coupled to the display 101, memory 103, and input means 102. The processor is capable of executing the program code for the calculator to perform a method to solve chemistry or physics problems. The method includes the following steps: displaying 107 a list of topics, said topics may include one or more chemistry topics or physics topics; accepting 108 a user topic selection; displaying 109 a list of one or more equations related to said user topic selection, each of said equations including more than one variables; accepting 110 a user selection of an equation from said list of equations; optionally accepting 111 a user designation of one or more unknown variables for said user selection of an equation; accepting 112 user input of one or more values, and units where applicable, for one or more known variables for said user selection of an equation; calculating 113 one or more values, and units where applicable, of said one or more unknown variables; and displaying 114 said values of one or more unknown variables, with units where applicable.

The display 101 can be a liquid crystal display (LCD), an organic light emitting diode (OLED) display, or another display that is suitable for a portable device. The input means 102 can include a keypad, a keyboard, a trackpoint, a trackball, a touchpad, a touch sensitive display, a mouse, and any combination thereof. The keypad may have number keys, letter keys, function keys, arrow keys, a select key, and a scroll wheel. The memory 103 can include random access memory (RAM), read only memory (ROM), erasable programmable read only memory (EPROM), flash memory, optical disk, and magnetic disk. The program code can be written in any one or more of the hundreds of computer programming languages such as C, C#, C++, Basic, Fortran, Java, JavaScript, Ruby, XML, and TI-Basic.

In another aspect of the embodiment, the calculator further includes the following method steps to solve chemistry or physics problems: displaying a list of sub-topics corresponding to a user selected topic, preferably right after a user has selected a topic; displaying a prompt for a known variable for said user selected equation; and displaying a calculation process with unit analysis. These steps are added at appropriate points in the execution of the method. For example, when a user has designated certain variables in an equation to be unknown variable, the calculator may begin to display a prompt for a known variable, for example “A=”, and the user may input a value at the prompt. If there are more variables, the calculator will display prompts for them too. In calculations that involve unit cancelation, it is helpful to display the process of the calculation with unit conversion and cancelation, for example, 2 Kg*2 m/s²=4 N, and for another example, 2 Kg/*4=8 Kg. It helps the user understand the physical principle behind the calculations.

In a further aspect of the embodiment, the topics may include one or more of the following: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density. The chemistry topics may be grouped together under a chemistry menu tab, and the physics topics may be grouped under a physics menu tab.

In certain aspects of the embodiment, the memory includes non-volatile storage medium such as flash memory so that said database and program will not be lost when power is out. On the other hand, the calculator may always include RAM (random access memory) coupled to the processor for fast processing. In other aspects, the calculator may further include a wired or wireless communication means to communicate with a network.

In various aspects, the input means may include an alphanumeric keypad, arrow keys, and a Select key. Where there are four arrow keys arranged in a cross arrangement or in a circle, the Select key may be conveniently located at the center of the arrow keys. In other various aspects, the input means may includes a touch sensitive display. In this case, the touch screen may be designed to include an on-screen alphanumeric keyboard, function keys, and scroll keys. An item displayed on the screen may also be selected by directly touching on the menu item itself. The touch screen may also include functions such as zoom in, zoom out, pan, and scroll.

In another aspect of the embodiment, the calculator may be designed to display menu tabs corresponding to one or more items selected from the following group: periodic table, problem topic chemistry, problem, equation, solve, operation, problem topic physics, math calculator, graph, and general idea.

In a further aspect, the menu tabs can be designed to have pull down menu that is arranged vertically. When a menu tab is selected, a pull down menu is displayed, said pull down menu including one or more sub-menu choices, each of which can be selected by the user. Alternatively, the menu items under a menu tab can be arranged in a horizontal pane or ribbon, in a manner similar to how the menu items are displayed in Microsoft Word 2010, thus allowing more menu items to be selected under one menu tab. In a yet further aspect, the sub-menu choices under the same menu tab are adapted such that they correspond to inputs from previous steps in solving a problem. Additionally, the label for the menu tab itself may change depending on the previous entries in a calculation sequence.

In another embodiment, a computer implemented method for solving chemistry and physics problems 200 includes the following steps: displaying a list of topics 201, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density; accepting a user topic selection 202; displaying a list of one or more equations 203 related to said user topic selection, each of said equations including more than one variables; accepting a user selection of a user selected equation 204 from said list of equations; optionally accepting a user designation of one or more unknown variables 205 for said user selected equation; accepting user input of one or more values, and units where applicable, for one or more known variables 206 for said user selected equation; and displaying one or more values, and units where applicable, of one or more unknown variables 207.

Here, data calculation including one or more values, and units where applicable, of said one or more unknown variables may take place at a user computer or at a remote computer. The term “computer” is broadly interpreted to include a single computing device and a network of computing devices. A computing device can be a PC compatible computer running Microsoft Windows, a Macintosh, a computer running Unix, a handheld device running iOS such as an iPhone or iPad, or a handheld device running Android or another operating system.

The method may include additional features and steps. In one aspect of the embodiment, the computer implemented method includes the following additional steps: displaying a list of sub-topics corresponding to a user selected topic; displaying a prompt for a known variable for said user selected equation; and displaying a calculation process with unit analysis.

In another aspect, the computer implemented method includes the following additional steps: displaying one or more menu tabs corresponding to one or more items selected from the group consisting of: periodic table, problem topic chemistry, problem, equation, solve, operation, problem topic physics, math calculator, math calculator, graph, and general idea; accepting a user selection of a menu tab; displaying a description and an indicator, indicating that said menu tab is selected; and displaying a pull down menu including one or more sub-menu choices, each of which can be selected by the user.

In yet another aspect, the description of a menu tab and the sub-menu choices corresponding to the menu tab are adapted according to inputs from previous steps in solving a problem. In still another aspect, a menu tab may be highlighted in response to a previous user input in a previous step. For example, the user previously selected the equation “M=Moles/V.” At this time, a menu tab F3 becomes highlighted-showing F3 as “F3 Solve” in bold, color, or highlight. Thus, the user is suggested to select “F3 Solve,” selection of which would lead to the display of a pull down menu, including “Solve for M,” “Solve for Moles,” and “Solve for V.”

In certain aspects, one or more steps of the method are carried out on a handheld computing device. This would include a standalone calculator where all the steps are carried out in the calculator, a networked calculator, a smart device such as an iPhone, an Android device, a device running another operating system, a tablet computer. In other aspects, the method may be carried out on a network system including at least a user computing device, a network, and a server computer. Here, the user computing device may be a computer, a handheld device, or may even be a thin terminal.

In another aspect, the method may include the step of displaying a graph of the user selected equation. This is a convenient feature for a user to visualize the relationship among the variables in a given chemical or physical equation, and the user would not need to create the same graph from scratch. Additionally, the user may be able to trace one or more curves in the graph to read the points of interest on the display.

In yet another embodiment, one or more non-transitory computer readable media 300 have processor readable program code embodied on at least one of said non-transitory computer readable media, said program code programming at least one processor to perform a method of chemistry and physics calculation, including the following steps: displaying a list of topics 301, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density; accepting a user topic selection 302; displaying a list of one or more equations 303 related to said user topic selection, each of said equations including more than one variables; accepting a user selection of a user selected equation 304 from said list of equations; optionally accepting a user designation of one or more unknown variables 305 for said user selected equation; accepting user input of one or more values, and units where applicable, for one or more known variables 306 for said user selected equation; calculating values, and units where applicable, of said one or more unknown variables; and displaying said values, and units where applicable, of one or more unknown variables 307. Here, the program code may be all stored on one computer readable medium on a computer local to a user, on an optical disc, on a flash drive, or on a magnetic disk drive. Alternatively, the program code may be distributed among more than one storage media. The program code may also be stored on one or more remote storage media and be sent to a user computing device via a network.

In another aspect of the embodiment, the method of chemistry and physics calculation further includes the steps of: displaying a list of sub-topics corresponding to a user selected topic; displaying a prompt for a known variable for said user selected equation; and displaying a calculation process with unit analysis.

In yet another aspect of the embodiment, the method of chemistry and physics calculation further includes the steps of: displaying one or more menu tabs corresponding to one or more items selected from the group consisting of: periodic table, problem topic chemistry, problem, equation, solve, operation, problem topic physics, math calculator, math calculator, graph, and general idea; accepting a user selection of a user selected menu tab; displaying a description and an indicator of said user selected menu tab, indicating that said user selected menu tab is selected; and displaying a pull down menu including one or more sub-menu choices, each of which can be selected by the user.

In various aspects, the description of a menu tab and the sub-menu choices corresponding to said menu tab are adapted according to inputs from previous steps in solving a problem. In other aspects, the method of chemistry and physics calculation is enabled to highlight a menu tab in response to a previous user input in a previous step. For example, a user previously selected the equation “M=Moles/V.” At this time, the menu tab F3 becomes highlighted-showing F3 as “F3 Solve” in bold, color, or highlight. Thus, the user is guided to select “F3 Solve” to display the pull down menu, including “Solve for M,” “Solve for moles,” and “Solve for V.”

In another aspect, the non-transitory computer readable media further includes processor readable program code for the processor to perform the additional method steps of: displaying a graph corresponding to the user selected equation; and tracing at least one curve on the graph.

### EXAMPLES

The principles of the present invention will now be illustrated through some specific examples that show how a user may use a chemistry calculator according to some embodiments of the present invention to solve various chemistry and physics problems. A person skilled in the art will appreciate that the examples described below are meant to explain how the teachings of the invention can be applied, rather than limiting the scope of the invention.

According to an embodiment of the invention, the chemistry calculator is designed to have the following home screen menu choices:

F1, Periodic Table: periodic table of the elements, constants, kₐ, k_{b}, melting point, boiling points, specific heat and most physical constants found in the chemistry and physics hand book.

F2, Problem Topic Chemistry: Contains most of the chapter topics in general chemistry text book such as balancing equations, stoichiometry, gas laws etc.

F3, Solve: Gives options what variable to solve from an equation such as PV=nRT or any other equations from all chapters. The label for F3 will be selected from Problem, Equation, and Solve depending on the stages in solving a problem.

F4, Operation: Provides many options to choose from for the equation at F3 step to solve the variable, usually F3 precedes F4.

F5, Problem Topic Physics: Contains most of the chapter topics in general physics text book such as mechanics, electricity, optics etc.

F6, Math Calculator: Evaluates math expressions.

F7, Graph: for graphing chemistry related topics and for other math function plots.

F8, General Idea: Other important chemistry and physics problem solving equations, such as volume or area of different objects, glossary for chemistry and physics or definitions of terms, SI and metric unit tables and much more.

The chemistry calculator has the capabilities of storing many pertinent chemistry and physics data and constants such as Kₐ, ΔH_{f}, Kᵢ and many others. Chemical equations stored, when needed, can be displayed in the following format:

A+B→C+D

The correct equation when needed will be selected from the list of equations stored in the calculator. Alternatively there will be a function to select reactants and products so that the user will be able to create a chemical equation they need in the above format and balance the equation.

To balance the equation, the necessary function will be selected and the correct coefficients can be entered for the reactants and products. This will allow for stoichiometry, equilibrium and gas law problems to be calculated with the proper unit.

Dimension analysis can be displayed on the screen of the calculator, and a user may be able to select a unit from a list of units. For example the user may press a key, or click on an icon, that says (UNIT) and all relevant chemistry and physics problems unit will be displayed. The user selects from this list to enter in the intended calculation. Alternatively, the unit for a calculation can be directly entered using an alpha-numeric keypad.

The operation of the chemistry calculator according to one embodiment of the present invention will now be illustrated through the following examples in which various chemistry and physics problems are solved.

### Example 1

### Gas Law Problem

A sample of gas at 15° C. and 1 atm has a volume of 2.58 L. What volume would this gas occupy at 38° C. and 1 atm?

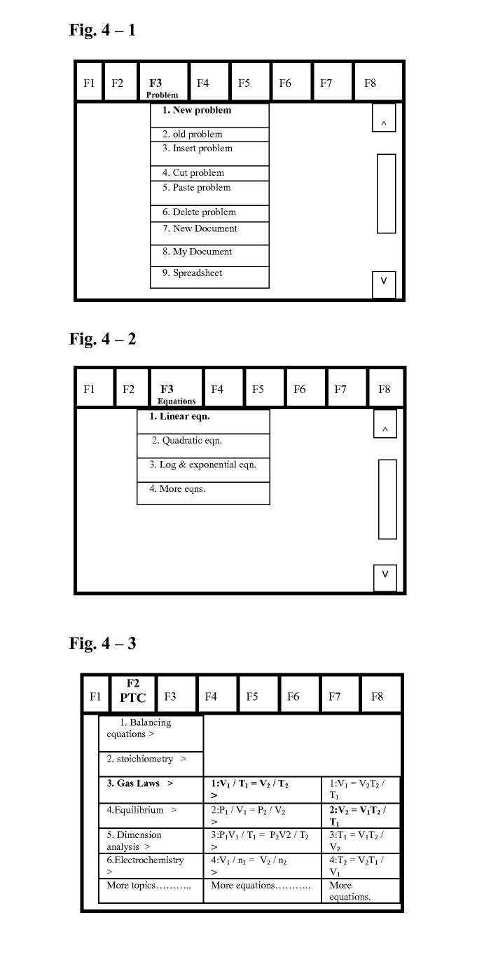

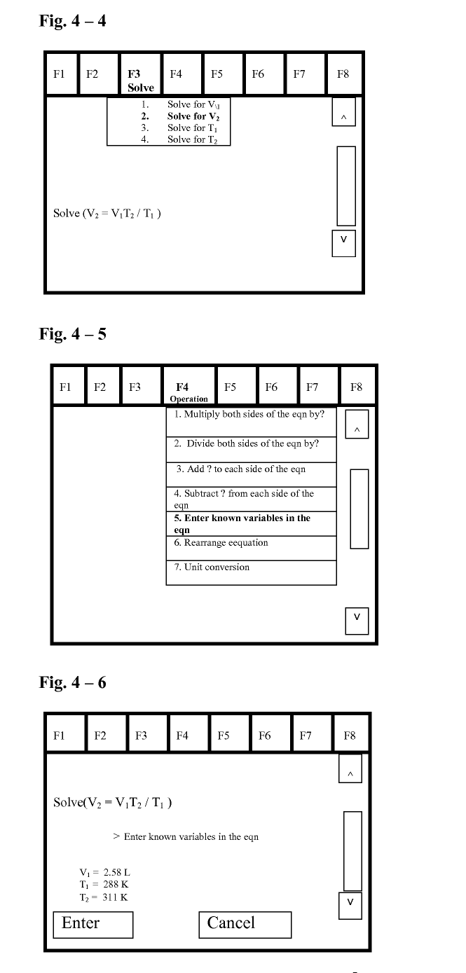

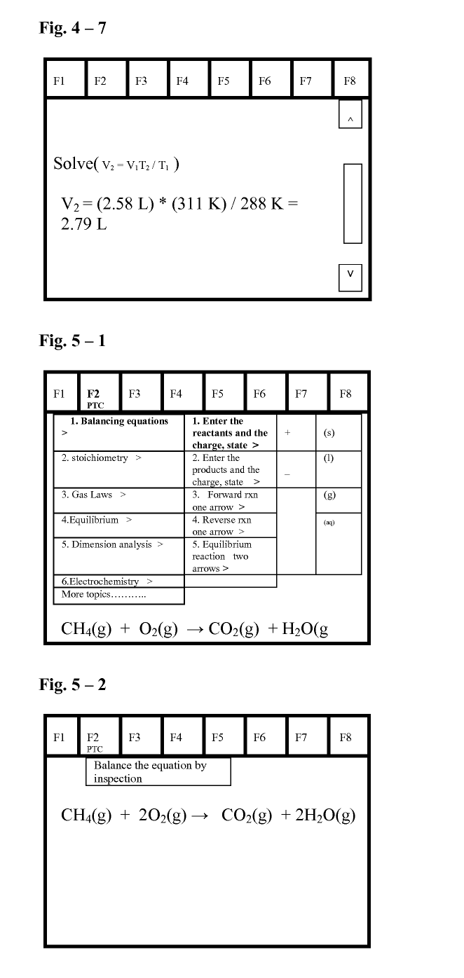

As shown in FIG. 4-1, a user will begin with F3-Problem to choose “New Problem” if the user has not worked on and saved this problem in the calculator in the past. Other menu choices under F3-Problem may include Old Problem, Insert Problem, Cut Problem, Paste Problem, Delete Problem, New Document, My Document, and Spreadsheet. Navigation among the menu choices F1-F8 can be achieved by pressing the left-right arrow keys on the calculator. The current menu choice will be highlighted in bold, color or shade and will be expanded to show its label, such as Periodic Table for F1, Problem Topic Chemistry for F2, and Problem for F3, etc. Pressing a Select key will select the currently highlighted menu choice, causing the pull down menu thereunder to be displayed. The Select key can be conveniently designed to be the center key among the arrow keys. Alternatively, a menu choice can be made by moving a pointer on the screen and then clicking on the appropriate menu choice, for example, moving the pointer to F3 and clicking on it by either pressing a button on the calculator or touching the screen if the screen is a touch-screen. The pointer can be moved using a touchpad, a roller, a trackpoint, a mouse, a touch screen, or other user interface. The sub-menu choices under F3 will expand and appear on the screen once F3 is selected. The sub-menu choices under F3 can be selected by clicking the up-down arrow keys on the calculator, and the currently selected choice will be highlighted in bold, color, or shade. Pressing the Select key will select the sub-menu choice, or will expand the sub-menu choice to lower level sub-menu choices if they exist. Here, there is no lower level sub-menu choice under New Problem, so selecting New Problem allows the user to go to the next step in the process. To solve the problem in this example, the user must choose a correct equation for the problem from a list of gas law equations stored in the calculator, and this is accomplished in the following steps.

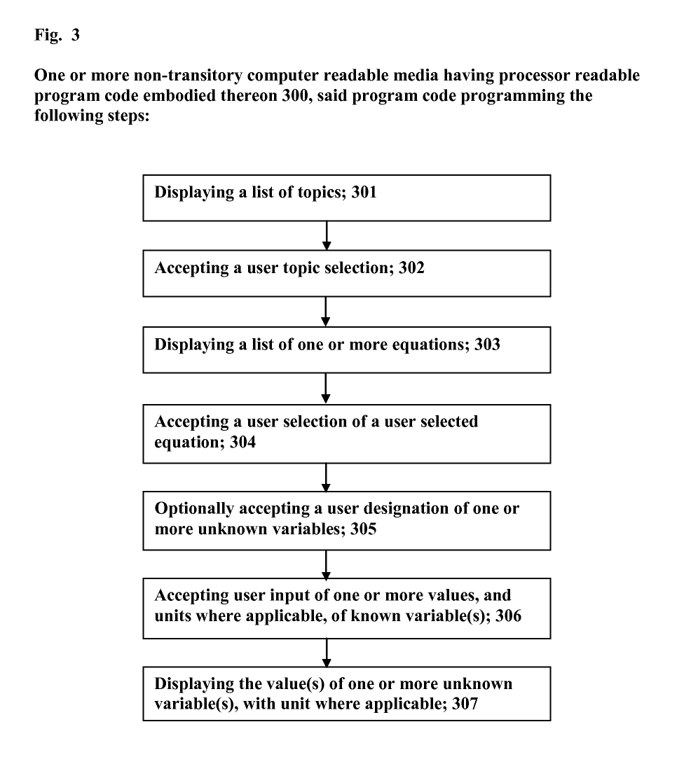

After the user selects F3→New Problem, the label for F3 becomes Equations, as shown in FIG. 4-2. The sub-menu choices include Linear Eqn., Quadratic Eqn., Log & Exponential Eqn., and More Eqns. Because solving the gas law problem here requires solving linear equations, the user should choose Linear Eqn.

Next, the user will choose from F2 PTC “Problem Topic Chemistry” among Balancing Equations, Stoichiometry, Gas Law, Equilibrium, Dimension Analysis, Electrochemistry, and More Topics as shown in FIG. 4-3. Because the problem in this example involves the calculation of gas volume, the user chooses Gas Law. There are two lower levels of sub-menu choices under Gas Law. The basic equations “1: V₁/T₁=V₂/T₂,” “2: P₁/V₁=P₂/V₂,” “3: P₁V₁/T₁=P₂V₂/T₂,” and “4: V₁/n₁=V₂/n₂” are displayed as the first lower level sub-menu under Gas Laws. If the desired equation is not found, the user can choose More Equations. In in this example, the question involves only volume and temperature, so the user chooses “1: V₁/T₁=V₂/T₂,” which causes the calculator to display the next lower sub-menu choices “1: V₁=V₂T₂N₁,” “2: V₂=V₁T₂/T₁,” “3: T₁=V₁T₂/V₂,” and “4: T₂=V₂T₁/V₁.” Here the question is to solve the volume of the gas at a given second temperature, so the user chooses “2: V₂=V₁T₂/T₁.”

The equation “V2=V₁T₂/T₁” is then displayed on the screen in the working area, as shown in FIG. 4-4. The user needs to tell the calculator which variable in the equation is the unknown variable that needs to be solved. At this step, the label for F3 changes to Solve. Selecting F3 causes the submenu choices “1. Solve for V₁,” “2. Solve for V₂,” “3. Solve for T₁,” and “4. Solve for T₂” to be displayed. Here, the user chooses “2. Solve for V₂.”

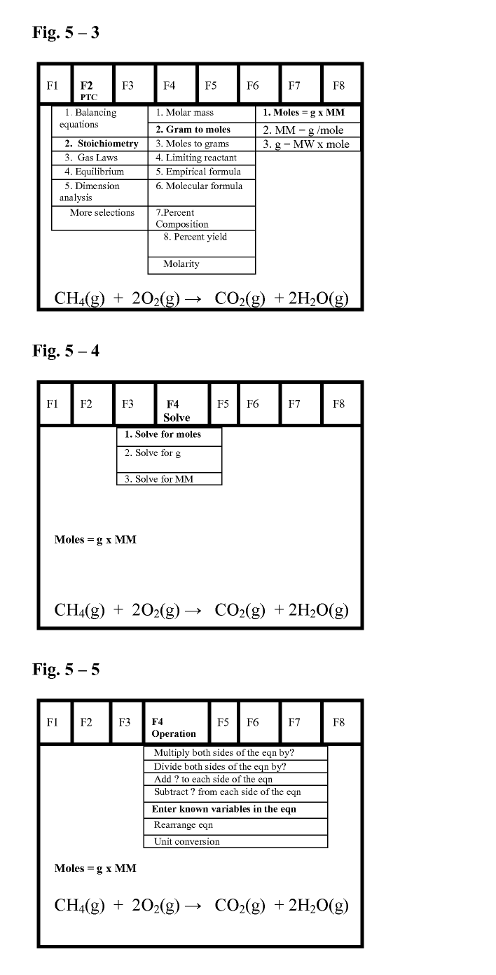

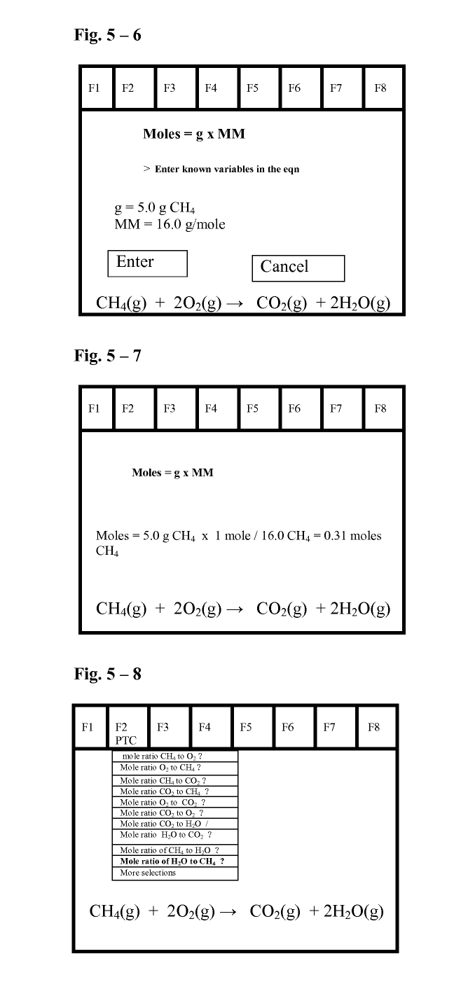

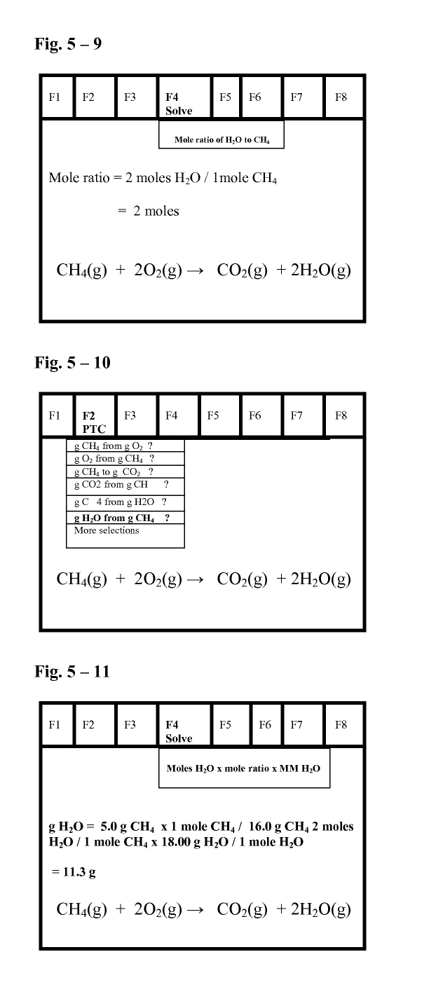

The user would select “F4 Operation” in the next step, as shown in FIG. 4-5. The sub-menu choices are “1. Multiply both sides of the eqn by?” “2. Divide both sides of the eqn by?” “3. Add ? to each side of the eqn,” “4. Subtract ? from each side of the eqn,” “5. Enter known variables in the eqn,” “6. Rearrange equation,” and “7. Unit conversion.” Here, the user should choose “5. Enter known variables in the eqn.”

As shown in FIG. 4-6, the calculator prompts the user to input the values for the variables V₁, T₁, and T₂. The user must input a unit for each variable, for example, V₁=2.58 L (liters), T₁=288 K, and T₂=311 K. The units L and K can be input by an alphanumeric keypad on the calculator, and any valid unit will be recognized by the calculator. The buttons Enter and Cancel are displayed. The user can move the cursor or highlight over these buttons and hit the Select key on the keypad to start the calculation. The user can also move a pointer over the clickable button and click on it. Alternatively, the user can press the Enter key on the alphanumeric keypad the start the calculation.

As shown in FIG. 4-7, the calculator substitutes the value of the variables into the equation and displays the process of the calculation: V₂=(2.58 L)*(311 K)/(288 K)=2.79 L. The user can see the process of unit cancelation in the calculation. Here, the unit in 311 K and 288 K cancels out, leaving the result in L. Note here that the user input 311 K and 288 K, rather than 38° C. and 15° C. (Celsius). The unit will also cancel out in the latter case, but the result will be wrong. The calculator in this case will check to make sure that the unit K is used. If ° C. is used, the calculator will give an error message. The calculator may also give a short explanation with the error message.

The steps described above are interconnected. As the user finishes one step, the function menu choice for the next step will be highlighted so that the user knows what the next step should be. For example, once the user selects an equation under F2, F3 is expanded to display “F3 Solve” and is highlighted. Pressing the down arrow moves the highlight to the sub-menu choices under F3. The label for F3 will change depending on which step it is in the process. The sub-menu choices under each function are also variable depending on the choices made in the previous menu steps and on the content displayed on the screen.

### Example 2

### Stoichiometry Problem

For the chemical reaction below, if you start with 5 g of methane, how many grams of water will be produced:

CH₄(g)+2O₂(g)→CO₂(g)+2H₂O(g)

The user will select the pull down menu choice “New Problem” from F3 Problem. The label for F3 changes to Equation. The user then selects “Linear Eqn.” from F3 Equations. The menu choice F2 PTC becomes highlighted, and the user presses the up and down arrows to navigate among the pull down menu choices under F2, as shown in FIG. 5-1. The user selects “1. Balancing equations,” and the calculator displays the lower level sub-menu choices “1. Enter the reactants and the charge, state >,” “2. Enter the products and the charge, state >,” “3. Forward reaction one arrow,” “4. Reverse reaction one arrow,” and “5. Equilibrium reaction two arrows.” Here, the user selects “1. Enter the reactants, the charge, and state >.” The user is then able to enter the chemical equation using the alphanumeric keypad on the calculator.

As shown in FIG. 5-2, when the user is inputting the chemical equation, the menu item F2 PTC is highlighted, and it has the sub-menu choice “Balance the equation by inspection,” which the user selects. The cursor will appear next to the reactants to enter the coefficients. This cursor can be moved among reactants and products to balance the equation, reactant side and product side. When the equation is improperly balanced there will be an error message below the equation, and as shown, when the equation is properly balanced, there is not an error message on the screen.

At this point the user goes back and selects F2, “problem topic chemistry” again and highlights and chooses “2. Stoichiometry” from the pull down menu, as shown in FIG. 5-3. The lower level sub-menu choices “1. Molar mass,” “2. Gram to moles,” “3. Moles to grams,” “4. Limiting reactant,” “5. Empirical formula,” “6. Molecular formula,” “7. Percent composition,” “8. Percent yield,” and “9. Molarity” are displayed. The user will first need to convert the 5 g methane to moles methane, so the user selects “2. Gram to moles” and then select “1. Moles=g/MM” from the next level menu.

As shown in FIG. 5-4, the menu item F4 Solve becomes highlighted, when selected, the pull down menu appears, including “1. Solve for moles,” “2. Solve for g,” and “3. Solve for MM.” Here, MM stands for Molar Mass. The user will select “1. Solve for moles.”

The menu item F4 Operation then becomes highlighted, as shown in FIG. 5-5. Selecting F4 causes the sub-menu items “1. Multiply both sides of the eqn. by?” “2. Divide both sides of the eqn by?” “3. Add ? to each side of the eqn.” “4. Subtract ? from each side of the eqn.” “5. Enter known Variable in the eqn.” “6. Rearrange eqn.” and “7. Unit conversion” to be displayed. Here, the user selects “Enter known variables in the eqn.”

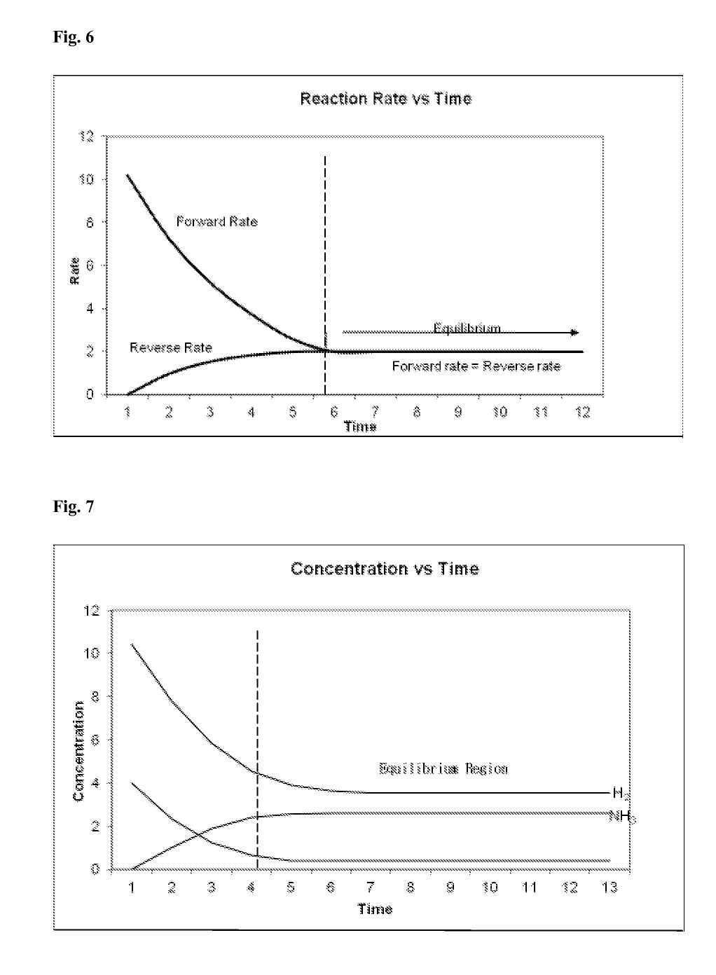

The calculator then prompts the user to input the known variables (FIG. 5-6). At the prompt “g=” the user inputs “5.0 g CH₄,” and at the prompt “MM=” the user inputs “16.0 g/mole CH₄.” The user hits enter to start the calculation.

As shown in FIG. 5-7, the calculator displays the process of the calculation with the proper units displayed:

Moles=(5.0 g CH₄)/(16 g/mol CH₄)=0.31 moles

Next, the user selects F2 PTC (FIG. 5-8), and the calculator displays the drop down menu items “Mole ratio CH₄ to O₂?” “Mole ratio O₂ to CH₄?” “Mole ratio CH₄ to CO₂?” “Mole ratio CO₂ to CH₄?” “Mole ratio O₂ to CO₂?” “Mole ratio CO₂ to O₂?” “Mole ratio H₂O to CO₂?” “Mole ratio of CH₄ to H₂O ?” “Mole ratio of H₂O to CH₄?” “Mole ratio CO₂ to H₂O? ” and “More selections.” The user chooses “Mole ratio of CH₄ to H₂O ?” because this is the relevant question here. Note that the menu choices under F2 PTC are responsive to the chemical equation displayed on the screen and to the step location in solving the question. For example, the CH₄ and H₂O are taken from the chemical equation entered earlier.

As shown in FIG. 5-9, the calculator displays the prompt “Mole ratio=” and the user inputs “2 moles H₂O/1 mole CH₄”. When the user hits Enter, the calculator gives the next line “=2” showing the molar ratio.

The user then selects the menu item F2 PTC again, as shown in FIG. 5-10. The drop down menu choices are “g CH₄ from g O₂?” “g O₂ from g CH₄?” “g CH₄ to g CO₂?” “g CO₂ from g CH₄?” “g CH₄ from g H₂O?” “g H₂O from g CH₄?” and “More selections.” Here, the user chooses “g H₂O from g CH₄?”

Then the menu item F4 Solve becomes highlighted (FIG. 5-11), and the user will select and enter the only sub-menu item “Moles CH₄×mole ratio×MM H₂O.” The calculator now has enough information to complete the calculation and displays the following result on the screen:

g H₂O=(5.0 g CH₄)/(16.0 g/mol CH₄)×(2 moles H₂O/1 mole CH₄)×(18.00 g/mole H₂O)=11.3 g

Another scenario for solving this type of problem is, for the calculator to draw the elements from the periodic table stored in the calculator when the user enters the equation written below:

CH₄+2O₂→CO₂+2H₂O

The above reaction will be balanced by the user, the atomic weights are recognized by the calculator for each element drawn since it is connected to the periodic table stored in the calculator. As discussed above, the calculator transforms a large chemistry problem into a series of connected multiple choice questions. The user needs to input the value and unit for variables, and the user needs to make the correct choices from a multitude of sub-menu choices.

### Example 3

### Equilibrium Problems

At a certain temperature, 4.0 mol of NH₃ is introduced into a 2.0 L container, and the NH₃ is partially dissociated by the reaction: 2NH₃ ((g)) [symbol] N₂ ((g))+3H₂ ((g)). At equilibrium 2.0 mol of NH₃ remains. What is the value of K for the reaction?

The user should be able write the equation and balance it first, in other words the user will go to a list of molecular formulas and select the reactants and products and set up the chemical equation.

The user will enter the K expression from the equation as follows:

K=[N₂][H₂]³/[NH₃]²

The calculator recognizes the bracket, [ ] as moles per liter concentration unit or other concentration units.

The user will set up an ICE table, (Initial, Change, and Equilibrium table) by pressing the right key on the keyboard, maybe {ICE}.

The values will be entered in the ICE table and the K calculated by substituting the values on the K expression. User first would have to solve for x without the calculator on the ICE table and substitute in the K expression.

2NH₃(g) [symbol] N₂(g)+3H₂(g)

| | | | |
|---|---|---|---|
| I | 4.0 mol | 0 | 0 |
| C | −2x | +3x | x |
| E | 4.0 − 2x | 3x | x |

The user must solve for x manually, x=[N₂]=0.5 moles/L in this case.

In another aspect, the pH scale is stored in the calculator in the range from 0-14. The equations involved in calculating pH are also stored in the calculator and can be displayed on the screen when needed. For example:

pH=−log [H⁺]

The pH value should also be set up to follow significant rules. The calculator should give the correct significant figures to all the calculations by following the significant rules.

### Example 4

### Unit Conversions

The user will perform unit conversion with dimension analysis, the prior art only perform unit conversion without unit analysis or dimension analysis.

For example, convert 5.0 m to inches.

The user will choose the key for dimension analysis or unit analysis, and sets up the unit cancellation as follows:

5.0 m×100 cm/1.0 m×1.0 in/2.54 cm=1.9×10² in

All the above set up with units should be displayed on the calculator screen with the correct answer with the correct unit, if the user sets up the unit cancellation wrong, the calculator should show an error message.

### Example 5

### Chemical Equilibrium Problem

A typical inorganic chemistry textbook for a college freshmen will have about 350-400 compounds and molecules for an equilibrium chapter end problems involving chemical equations. How do we represent these equations in the calculator to the user?

All these chemical equations can be displayed to the user possibly by selecting a key from the keyboard or from a pull down menu from the screen. This will display all the necessary molecules and compounds on the screen alphabetically in the following manner:

NH₃(g),NH₄OH(aq),N₂(g)

O₂(g),O₃(g)

PH₃(g),PO₄⁻³(aq)etc.

NaCl(s)

The user proceeds to select the reactants and products as stated above and completes writing the chemical equation.

First from the list above the user will highlight or place the cursor in the front of the compound or molecule or ion and hit enter, one of the reactants will be selected. Then proceeds selecting more reactants from the list if needed and places an arrow for forward and reverse reactions and a double arrow for an equilibrium reaction. The calculator is programmed to recognize what the arrows mean. Then the user proceeds to select the reactants and completes writing the chemical equation.

Next the user will select a key from the keyboard or the pull down menu for (Bal) to balance the chemical equation. The user will place the cursor in front of the compound, molecule, or ion and enter the coefficients for reactants and products and the equation is balanced.

The calculator is also programmed that the state (g), (s), (l), and (aq) mean at room temperature condition 20-21 degree centigrade. In other words the boiling point and melting point of each substances in the list above can be programmed and respond for temperature change conditions in the chemical equation.

### Example 6

### Chemical Equilibrium Problem Solving

For example, if the equilibrium problem involves the following equation:

H₂O(l)+CO(g) [symbol] H₂(g)+CO₂(g)

The calculator will recognize that this is an equilibrium problem, because once the sub-menu item Equilibrium is selected and the double arrow is setup in the equation, the calculator will associate this to the requirements for equilibrium reaction mode.

The differential equations for the above equilibrium equation will also be recognized by the calculator for the above equation.

Rate=−Δ[H₂O]/Δt=−Δ[CO]/Δt=Δ[H₂]/Δt=Δ[CO₂]/Δt

The rate of disappearance of the reactants to the appearance of products is programmed and can be monitored by the following plot for this equilibrium reaction and other reactions.

The “F7 Graph” menu tab is selected from the pull down menu to view the plot for that particular equilibrium reaction, see FIG. 6.

Similarly the concentration versus time plot will be associated to the equilibrium reaction above. FIG. 7 shows a similar plot for

H₂(g)+N₂(g)→2NH₃(g)

The calculator is capable for the user to move the dashed line left and right on each plot and see the shifting of the equilibrium to view changes in rate and concentration at any time.

The equilibrium equation is incorporated to the law of mass action expression K through a generic equation programmed in the calculator:

iA+jB [symbol] kC+lD with the equilibrium expression:

K=[C]^{k}[D]^{l}/[A]^{I}[B]^{j}

The square brackets are the equilibrium concentrations usually moles/L. All the above equations, plots and K are connected or programmed to function when “Equilibrium” is selected from the pull down menu. Note that K for the equilibrium expression is identified from Ka and Kb for acid base equilibrium constants in the calculator's program.

By choosing K for a balanced reaction the user will be prompted to enter the concentrations of each species, the user enters the data: [C]=0.921M, [D]=0.763M, [A]=0.375M, and [E]=0.345M.

The user will select or hit the enter key, the calculator will display the answer for K without unit, since K has no units. The calculator recognizes what the letter V means (volume) in an aqueous or gaseous problem solving.

### Example 7

### Dilution Problem

For example to calculate the volume (V) of a 0.1 M NaOH (aq) solution needed to make 100 mL of 0.01 M solution of NaOH (aq), the following formula needs to be pulled out of the calculator and displayed in the screen. This can be achieved by selecting “Dilution” from a pull down menu in the calculator.

The equation displayed at this point is: M₁V₁=M₂V₂

The Variables will be ready to be given the values or each in a row or one by one. M₁=0.1M, M₂=0.01M, and V₂=100 mL.

At this point when the enter key is selected the variable V₁ will be displayed with the answer with the correct unit. The calculator will be programmed with a standard unit for volume (Liter), the user has to convert it to the proper unit if needed using the unit conversion or dimension analysis function.

If the user is trying to balance a chemical equation but it is not correctly balanced, an error message will be displayed until it is correctly balanced. For a stoichiometry problem if the set up is incorrect, the user will try again and again until the set up is correct, otherwise the calculator will give an error message.

### Example 8

### Molar Mass And Atomic Mass

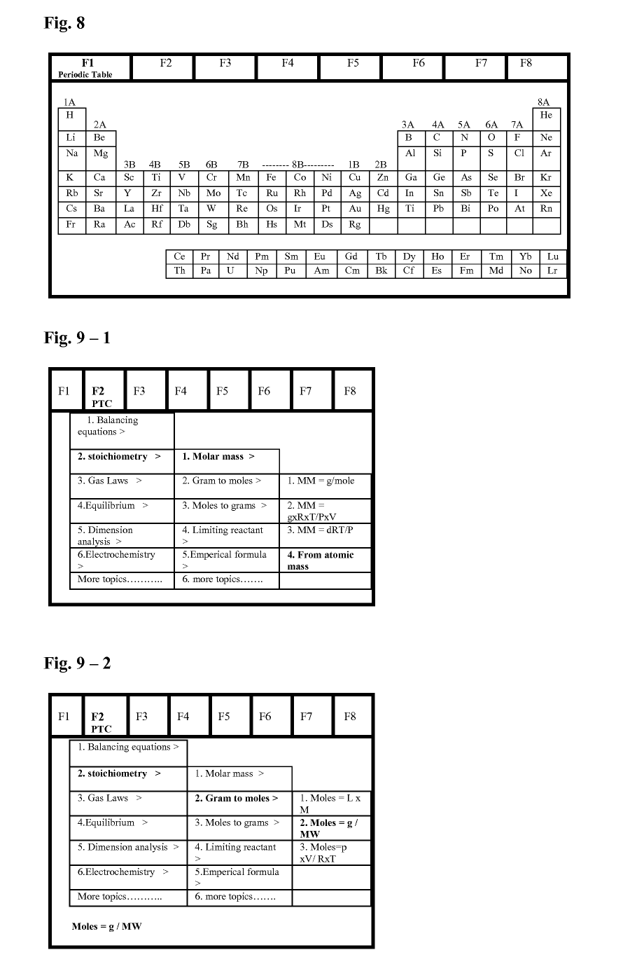

If a molar mass or atomic mass is needed for chemistry calculation the user selects F1 Periodic Table from the list of pull down menu's or the keyboard, as shown in FIG. 8. The periodic table will be displayed on the screen. If the screen resolution is not sufficiently high to display the whole periodic table, a partial periodic table will be displayed with the ability to scroll to the rest of the periodic table. The user may select the element from the periodic table and click on the element, and many chemical and physical properties including the atomic mass for the element will be displayed.

The periodic table is programmed to relate to each molecule or compound stored in the calculator weather it is a gas solid or liquid. In other words when a chemical equation is properly balanced, the law of definite proportion or the fact mass and energy are conserved will be recognized by the periodic table for each element in the equation associated with the compound or molecule.

Additionally, the calculator may have the following features: calculating chemical equilibrium; setting up a chemical equation and checking it for errors, plotting a graph, associating with the periodic table and storing the law of mass action; and the calculator identifies the phase (g), (l), (s), (aq) of a chemical compound molecule or ions, which stands for gas, liquid, solid, aqueous solutions. In addition, the calculator may be able to carry out the following functions: Dimension analysis, Chemical kinetics calculations, Electrochemistry calculations, Solving quadratic equations, Colligative properties calculations, Thermo chemistry calculations, and Stoichiometry calculations.

### Example 9

### Molarity Problem

Calculate the molarity of the following solution: A 6.523 g sample of NaHCO₃ is dissolved in enough water to make 360 mL of solution.

Similar to Example 1, as shown in FIGS. 4-1 and 4-2, the user will choose “1. New Problem” from the pull down menu under F3 Problem. The menu tab F3 then becomes “F3 Equation” and will be highlighted. The user will then choose “1. Linear Eqn” from the F3 Equation pull down menu.

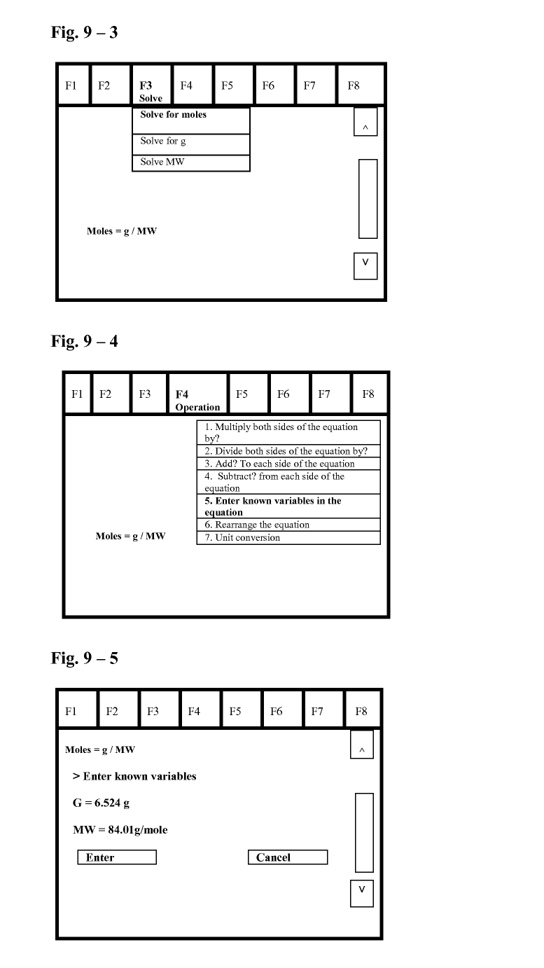

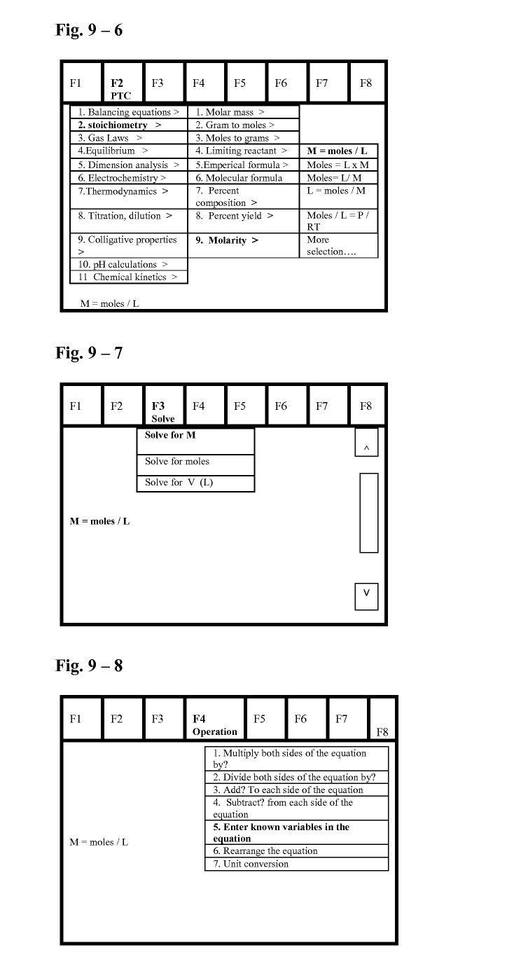

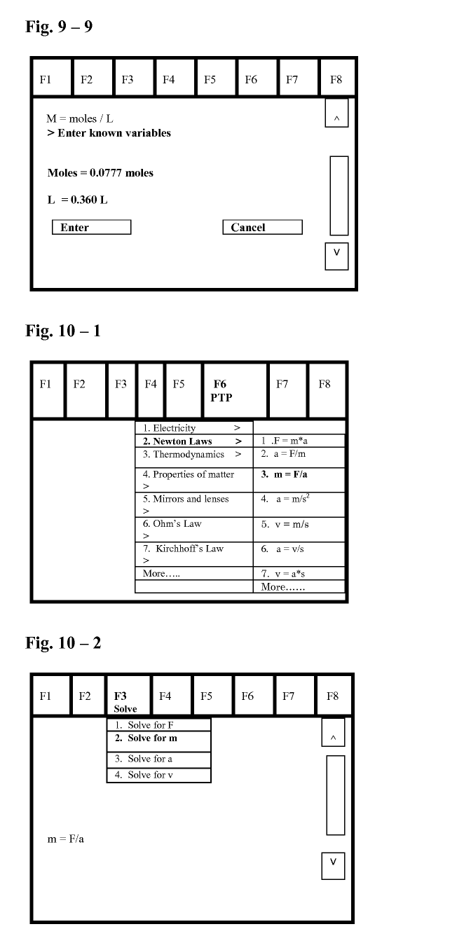

The user then selects the F2 PTC menu tab, as shown in FIG. 9-1. The user will follow the multi-level sub-menu to choose “2. Stoichiometry”→“1. Molar Mass”→“4. From Atomic Mass.”

Next the user selects “F1 Periodic Table” or just selects the choice from the pull down menu and finds the atomic mass from the periodic table displayed on the diagram below by clicking on the specific element on the periodic table, and then adds the atomic masses using the math calculator portion of the chemistry calculator.

At this time the user proceeds to select the correct equation by going back to F2 PTC “problem topic chemistry” as shown in FIG. 9-2 and from the multi-level pull down menu selects “2. Stoichiometry”→“2. Gram to moles”→“2. Moles=g/MW.”

Once the correct equation is selected and appears on the screen the user is guided to the next function F3 Solve as shown in FIG. 9-3. Based on the equation that is input or selected in the previous step, “Moles=g/MW,” the pull down menu under F3 now includes “Solve for moles,” “Solve for g,” and “Solve MW.” Here, the user selects “Solve for moles.”

As shown in FIG. 9-4, the menu tab F4 Operation becomes highlighted. The user selects F4 and then “5. Enter known variables in the equation” from the pull down menu.

In the following screen, as shown in FIG. 9-5, the user enters the known variables at the prompt and selects Enter on the screen or the keypad of the calculator. The calculator calculates and displays the result for this step.

Then the user carries the result of the calculation above to the next step to calculate the molarity of the solution in this problem. The user will choose F2 PTC, and select from the multi-level pull down menu to select “2. Stoichiometry”→“9. Molarity”→“M=Moles/L,” as shown in FIG. 9-6.

The equation “M=Moles/L” is displayed on the screen, as shown in FIG. 9-7. At this time, the menu tab F3 Solve becomes highlighted. The user selects the F3 Solve and the pull down menu appears, including “Solve for M,” “Solve for moles,” and “Solve for V (L).” The user selects “Solve for M.”

As shown in FIG. 9-8, the menu tab F4 Operation becomes highlighted. The user selects “5. Enter known variables in the equation.”

As shown in FIG. 9-9, the calculator takes the moles value from the previous calculation where “Moles=0.0777 moles,” so the calculator will only need to prompt the user with “L=.” The user inputs “0.360 L” and selects “Enter” on the screen or pushes the Enter key on the keypad. The chemistry calculator then displays the calculation process with unit cancelation and the calculation result with the correct unit: M=0.0777 moles/0.360 L=0.216 moles/L.

### Example 10

### Newton Law Problem

Some of the national football league weighs more than 305 pounds. At this weight, their Body Mass Index (BMI) places them at Grade 2 obesity, which is one step below morbid obesity. Determine the mass of a 305 pound (1352 N) football player.

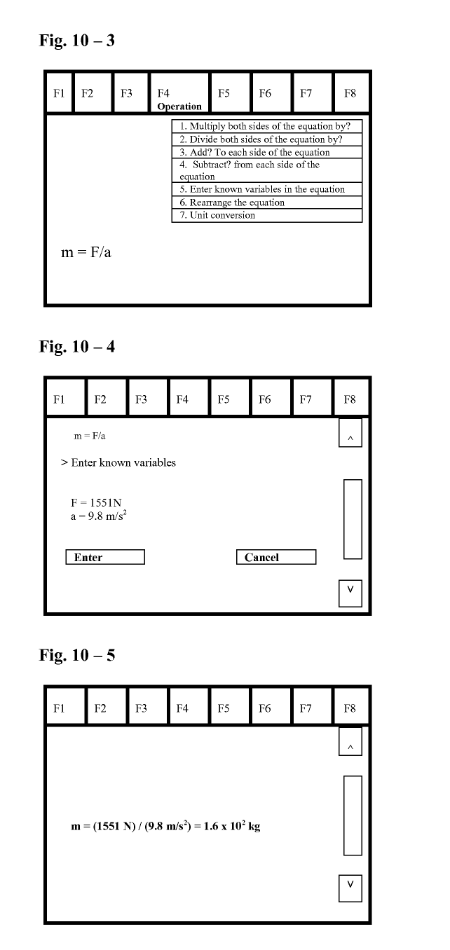

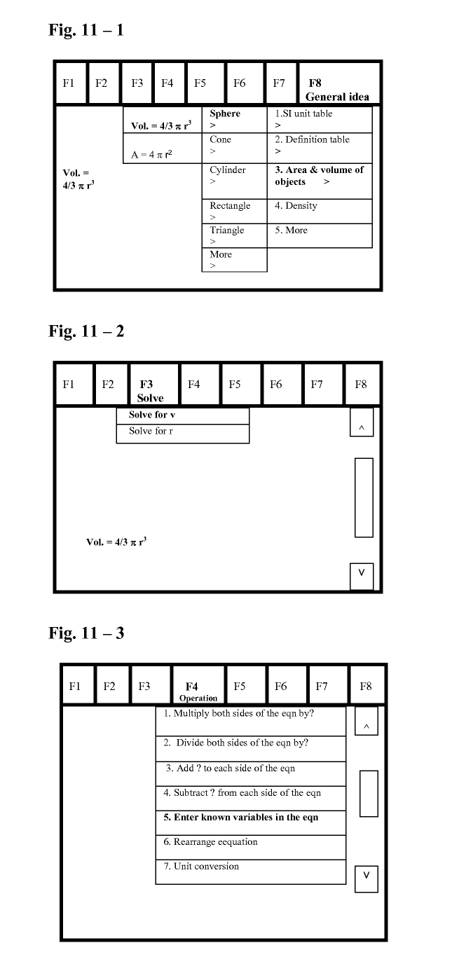

The user will choose “1. New Problem” from the pull down menu F3 Problem and then “Linear Eqn” from the updated F3 Equation pull down menu. As the user moves among the function tabs, the selected function tab expands to display the full name of the function tab. The drop down menu will be displayed if the select key or the down arrow key is pressed. Alternatively, as the user scrolls among the function tabs, the pull down menu for the selected function tab is automatically displayed. Here the question is a physics question, so the user will choose F6 PTP for “Problem Topics Physics,” as shown in FIG. 10-1. The sub-menu includes “1. Electricity,” “2. Newton Laws,” “3. Thermodynamics,” “4. Properties of matter,” “5. Mirrors and lenses,” “6. Ohm's law,” “7. Kirchhoff's law,” and “More.” The user moves the highlight or cursor to “2. Newton's law” and selects it by pressing the select key, right arrow key, or Enter key on the keypad, and the next level sub-menu is displayed. Alternatively, the calculator automatically displays the next lower level sub-menu as the user scrolls among the higher level menu items. Here, the user chooses “m=F/a” from the lower sub-menu, which includes “1. F=m*a,” “2. a=F/m,” “3. m=F/a,” “4. a=m/s²,” “5. v=m/s,” “6. a=v/s,” “7. v=a*s,” and “More.”

The equation “m=F/a” is displayed on the screen, and the menu tab F3 is expanded to read F3 Solve and is highlighted, as shown in FIG. 10-2. The user will press the select key on the keypad, and the pull down menu under F3 is displayed, including “1. Solve for F,” “2. Solve for m,” “3. Solve for a,” and “4. Solve for v.” Here, the user will select “2. Solve for m.”

The function tab F4 then expands to read F4 Operation and is highlighted, as shown in FIG. 10-3. The user selects F4 Operation, and the pull down menu is displayed. Here, the user will use his/her judgment and select “5. Enter known variables in the equation.”

Here, there are three variables in the equation, m, F, and a. The calculator is told in an earlier step to “solve for m,” so the calculator prompts the user to enter the value for the other two variable, as shown in FIG. 10-4. The calculator prompts “F=,” and the user enters “1551 N.” Then the calculator prompts “a=,” and the user enters 9.8 m/s².”

As the user clicks on ENTER on the screen or hits the Enter key on the keypad, the calculator displays the calculation “m=F/a=(1351 N)/(9.8 m/s²)=138 kg” as shown in FIG. 10-5, with unit analysis for the calculation process. The calculator will check that the units for “F” and “a” match, and if not, the calculator will display an error message.

### Example 11

### Density Calculation

A star is estimated to have a mass of 2.0×10³⁸ kg. Assuming it to be a sphere of average radius 7.0×10⁶ Km, calculate the average density of the star in units of grams per cubic centimeter.

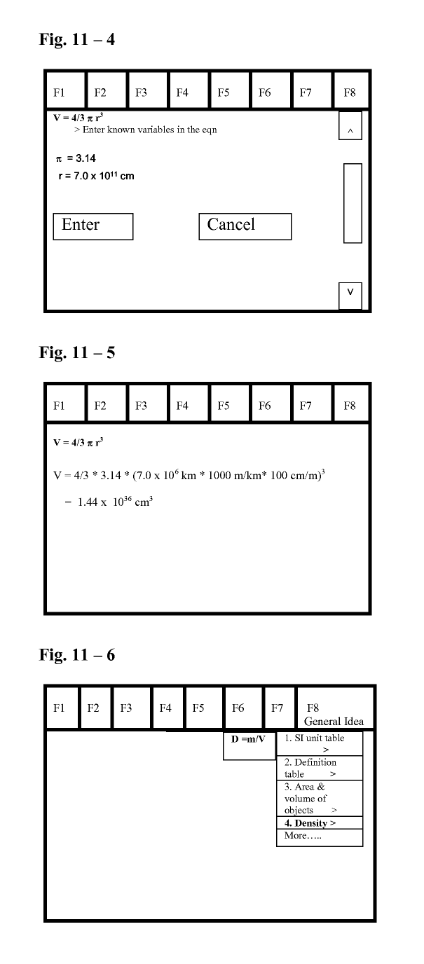

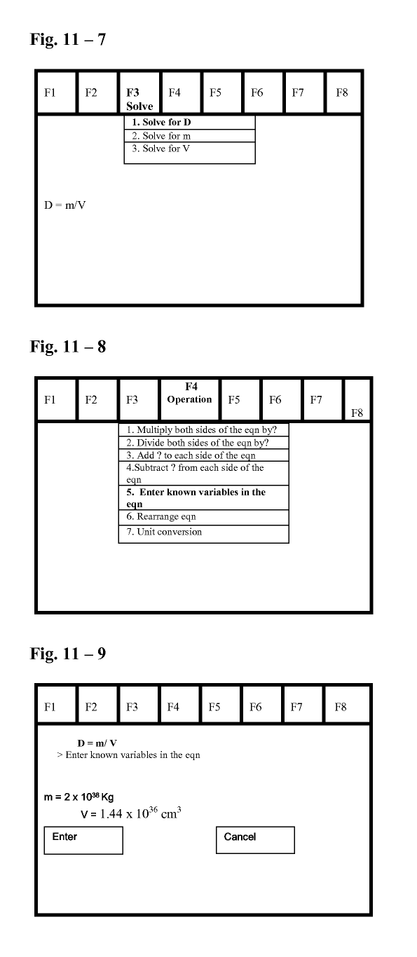

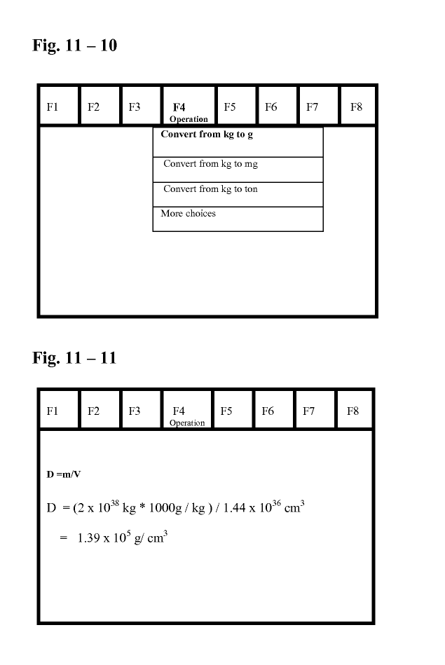

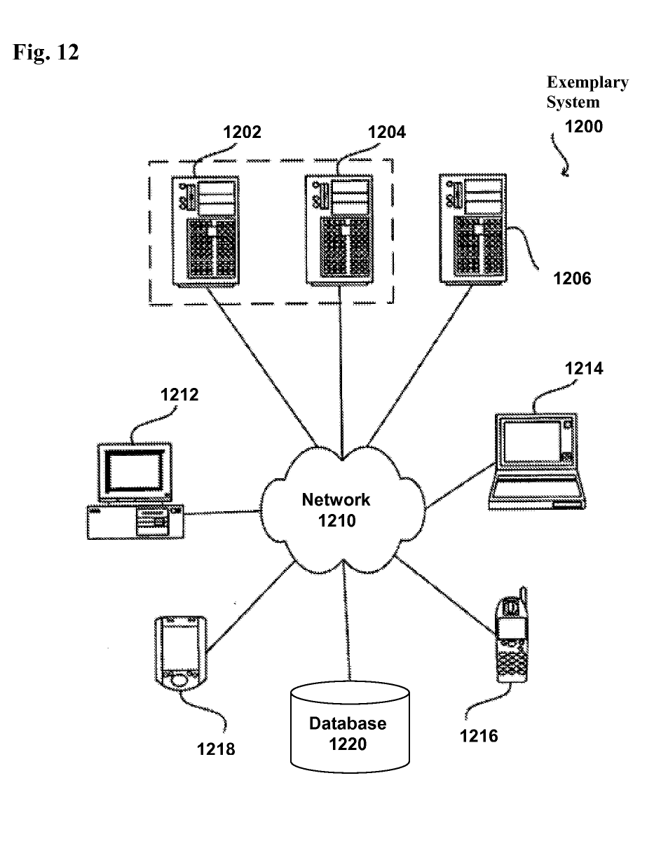

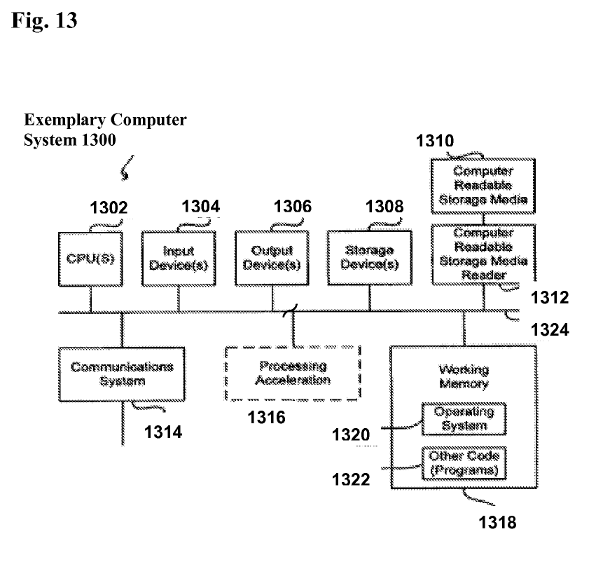

To begin the calculation, the user selects F3 Problem and then New Problem from the pull down menu thereunder. The label for F3 then changes to F3 Equation. The user will select F3 Equation and choose Linear Equation from the pull down menu under F3 Equation. Next, the user needs to first calculate the volume of the star. As shown in FIG. 11-1, the user selects F8 “General idea” that has useful formulas and equations under its scroll down menu, including “1. SI unit table >” “2. Definition table >” “3. Area & volume of objects >” “4. Density,” and “More.” The user chooses “3. Area & volume of objects.” The next level sub-menu is displayed, including “Sphere >” “Cone >” “Cylinder >” “Rectangle >” “Triangle >” and “More.” Since the question to the problem pertains to a star that is a sphere, the user chooses “Sphere >.” The next level sub-menu is displayed, including the formulas “Vol=4/3 πr³” and “A=4π r².” The user chooses “Vol=4/3 πr³”, and then the equation “Vol=4/3 πr³” is displayed on the screen.

As shown in FIG. 11-2, the menu tab F3 expands to read F3 Solve as soon as the equation is displayed. There are two variables in the formula “Vol=4/3 πr³”, Vol and r, and the calculator needs to be told which one of them is the known variable that is to be input by the user, and which one is the unknown variable that is to be solved. The user selects F3 and then selects “Solve for v.”

The menu tab F3 Solve then retracts to read F3, and the menu tab F4 expands to read F4 Operation and is highlighted, as shown in FIG. 11-3. The user then selects F4 Operation and the sub-menu item “5. Enter known variables in the eqn.”

As shown in FIG. 11-4, the calculator displays a status message “>Enter known variables in the eqn.” The value of π is displayed “π=3.14” because it is a constant that is stored in the calculator. The calculator displays the prompt “r=,” and the user inputs the value and unit 7.0×10¹¹ cm. The user then clicks the “Enter” button on the screen or presses the enter key on the keypad to carry out the calculation. The calculation process and result are shown in FIG. 11-5, V=4/3*3.14*(7.0×10¹¹ cm)³=1.44×10³⁶ cm³.

The next step is for the user to solve for density. As shown in FIG. 11-6, the user now selects the function F8 General Idea and then selects the menu choice “4. Density.” There is only one sub-menu choice under Density, which is “D=m/V.” The user selects the equation.

As shown in FIG. 11-7, the equation “D=m/V” is displayed in the main area on the screen. The menu tab F3 is expanded to read “F3 Solve” and is highlighted. The user selects F3, and the calculator displays the pull down menu that includes “1. Solve for D,” “2. Solve for m,” and “3. Solve for V.” The user selects “1. Solve for D.”

As shown in FIG. 11-8, the drop down menu for F3 retracts, and the label for “F3 Solve” shrinks to F3. The label for F4 expands to read F4 Operation and is highlighted because this is the next step that the calculator suggests. The user then selects F4 Operation, and the drop down menu is displayed. The user selects “5. Enter known variables in the eqn.”

Here, the volume was calculated from the previous step, so the calculator only prompts the user to input the value for m, as shown in FIG. 11-9. The user inputs “2×10³⁸ kg.” Since the question asked the answer to have the unit of g/cm³, the 2×10³⁸ kg has to be converted to grams before the final density calculation is carried out. To do this, the user will select F4, Operation, and the submenu choices will be displayed, including “Convert from kg to g,” “Convert from kg to mg,” “Convert from kg to ton,” and “More choices,” as shown in FIG. 11-10. Here, the user selects “Convert from kg to g.”

The sub-menu under F4 then retracts, and the calculator return to the main display. Upon pressing the enter key on the screen or the key pad, the calculator returns the calculation process with unit analysis and the result, D=(2×10³⁸ kg)*(1000 g/kg)/(1.44×10³⁶ cm³)=1.39×10⁵ g/cm³, as shown in FIG. 11-11.

FIG. 12 is a block diagram illustrating components of an exemplary operating environment in which embodiments of the present invention may be implemented. The system 1200 can include one or more user computers, computing devices, or processing devices 1212, 1214, 1216, 1218, which can be used to operate a client, such as a dedicated application, web browser, etc. The user computers 1212, 1214, 1216, 1218 can be general purpose personal computers (including, merely by way of example, personal computers, tablets, and/or laptop computers running a standard operating system), cell phones, smart phones such as iPhones and Android phones, calculators or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1212, 1214, 1216, 1218 may also have any of a variety of applications, including one or more development systems, database client and/or server applications, and Web browser applications. Alternatively, the user computers 1212, 1214, 1216, 1218 may be any other electronic device, such as a thin-client computer, Internet-enabled gaming system, and/or personal messaging device, capable of communicating via a network (e.g., the network 1210 described below) and/or displaying and navigating Web pages or other types of electronic documents. Although the exemplary system 1200 is shown with four user computers, any number of user computers may be supported.

In most embodiments, the system 1200 includes some type of network 1210. The network can be any type of network familiar to those skilled in the art that can support data communications using any of a variety of commercially-available protocols, including without limitation TCP/IP, SNA, IPX, AppleTalk, and the like. Merely by way of example, the network 1210 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 1202, 1204, 1206 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1206) may be dedicated to running applications, such as a business application, a Web server, application server, etc. Such servers may be used to process requests from user computers 1212, 1214, 1216, 1218. The applications can also include any number of applications for controlling access to resources of the servers 1202, 1204, 1206.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1212, 1214, 1216, 1218. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1212, 1214, 1216, 1218.

The system 1200 may also include one or more databases 1220. The database(s) 1220 may reside in a variety of locations. By way of example, a database 1220 may reside on a storage medium local to (and/or resident in) one or more of the computers 1202, 1204, 1206, 1212, 1214, 1216, 1218. Alternatively, it may be remote from any or all of the computers 1202, 1204, 1206, 1212, 1214, 1216, 1218, and/or in communication (e.g., via the network 1210) with one or more of these. In a particular set of embodiments, the database 1220 may reside in a storage-area network (“SAN”) familiar to those skilled in the art. Similarly, any necessary files for performing the functions attributed to the computers 1202, 1204, 1206, 1212, 1214, 1216, 1218 may be stored locally on the respective computer and/or remotely, as appropriate. In one set of embodiments, the database 1220 may be a relational database, such as Oracle 10 g, that is adapted to store, update, and retrieve data in response to SQL-formatted commands.

FIG. 13 illustrates an exemplary computer system 1300, in which embodiments of the present invention may be implemented. The system 1300 may be used to implement any of the computer systems described above. The computer system 1300 is shown comprising hardware elements that may be electrically coupled via a bus 1324. The hardware elements may include one or more central processing units (CPUs) 1302, one or more input devices 1304 (e.g., a mouse, a keyboard, etc.), and one or more output devices 1306 (e.g., a display device, a printer, etc.). The computer system 1300 may also include one or more storage devices 1308. By way of example, the storage device(s) 1308 can include devices such as disk drives, optical storage devices, solid-state storage device such as a random access memory (“RAM”), flash memory, and/or a read-only memory (“ROM”), which can be programmable, flash-updateable and/or the like.

The computer system 1300 may additionally include a computer-readable storage media reader 1312, a communications system 1314 (e.g., a modem, a network card (wireless or wired), an infra-red communication device, etc.), and working memory 1318, which may include RAM, flash memory, and ROM devices as described above. In some embodiments, the computer system 1300 may also include a processing acceleration unit 1316, which can include a digital signal processor DSP, a special-purpose processor, and/or the like.

The computer-readable storage media reader 1312 can further be connected to a computer-readable storage medium 1310, together (and, optionally, in combination with storage device(s) 1308) comprehensively representing remote, local, fixed, and/or removable storage devices plus storage media for temporarily and/or more permanently containing, storing, transmitting, and retrieving computer-readable information. The communications system 1314 may permit data to be exchanged with the network and/or any other computer described above with respect to the system 1300.

The computer system 1300 may also comprise software elements, shown as being currently located within a working memory 1318, including an operating system 1320 and/or other code 1322, such as an application program (which may be a client application, Web browser, mid-tier application, RDBMS, etc.). It should be appreciated that alternate embodiments of a computer system 1300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 13 further illustrates an environment where an on-demand distributed database service might be used. As illustrated in FIG. 13 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

An exemplary application platform peer to peer network includes an application setup mechanism that supports application developers' creation and management of applications, which may be saved as metadata into a database by save routines for execution by subscribers as one or more processes managed by distributed database management processes for example. Invocations to such applications may be coded using PL/SOQL that provides a programming language style interface extension to an application programming interface API or other suitable programming languages. Invocations to applications may be detected by one or more system processes which manage retrieval of application metadata for the subscriber making the invocation and executing the metadata as an application in a virtual machine.

It should also be understood that each application server may be communicably coupled to one or more distributed database systems, e.g., system database and multi-enterprise database(s), via a different network connection to form a peer to peer network. For example, one server might be coupled via the Internet, another server might be coupled via a direct network link, and another server might be coupled by yet a different network connection. Transfer Control Protocol and Internet Protocol (TCP/IP) are typical protocols for communicating between servers and one or more distributed database systems. However, it will be apparent to one skilled in the art that other transport protocols may be used to optimize the system depending on the network interconnect used to implement the peer to peer, distributed network.

Each of the one or more distributed database systems can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

While embodiments and applications of this disclosure have been shown and described, it would be apparent to those skilled in the art that many more modifications and improvements than mentioned above are possible without departing from the inventive concepts herein. Specific embodiments of components and processes are described to help clarify the invention. These are, of course, merely embodiments and are not intended to limit the invention from that described in the claims.

What is claimed is:

1. A calculator comprising:
a display;
an input means;
a memory including program code and a database; said database including common topics, equations, and constants in chemistry and physics; and
a processor coupled to said display, memory, and input means, said processor being capable of executing said program code for the calculator to perform the following method to solve chemistry or physics problems:
displaying a list of topics, said topics including one or more items selected from the group consisting of chemistry topics or physics topics;
accepting a user topic selection;
displaying a list of one or more equations related to said user topic selection, each of said equations including more than one variables;
accepting a user selection of equation from said list of equations;
optionally accepting a user designation of one or more unknown variables for said user selection of equation;
accepting user input of one or more value, and units where applicable, for one or more known variables for said user selection of equation;
calculating one or more values, and units where applicable, of said one or more unknown variables; and
displaying said values of one or more unknown variables, with units where applicable.

2. The calculator of claim 1, the method to solve chemistry or physics problem further comprising:
displaying a list of sub-topics corresponding to a user selected topic;
displaying a prompt for a known variable for said user selected equation; and
displaying a calculation process with unit analysis.

3. The calculator of claim 1, wherein said topics includes one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density.

4. The calculator of claim 1, wherein said memory includes non-volatile storage medium such as flash memory.

5. The calculator of claim 1, further comprising a communication means to communicate with a network.

6. The calculator of claim 1, wherein said input means includes an alphanumeric keypad, arrow keys, and a Select key.

7. The calculator of claim 1, wherein said input means includes a touch sensitive display.

8. The calculator of claim 1, being capable of displaying menu tabs corresponding to one or more items selected from the group consisting of: periodic table, problem topic chemistry, problem, equation, solve, operation, problem topic physics, math calculator, graph, and general idea.

9. The calculator of claim 8, wherein each menu tab is capable of being selected by a user, and when a menu tab is selected, a pull down menu is displayed, said pull down menu including one or more sub-menu choices, each of which can be selected by the user.

10. The calculator of claim 9, wherein said one or more sub-menu choices are adapted such that they correspond to inputs from previous steps in solving a problem.

11. A computer implemented method for solving chemistry and physics problems, comprising:
displaying a list of topics, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density;
accepting a user topic selection;
displaying a list of one or more equations related to said user topic selection, each of said equations including more than one variables;
accepting a user selection of a user selected equation from said list of equations;
optionally accepting a user designation of one or more unknown variables for said user selected equation;
accepting user input of one or more values, and units where applicable, for one or more known variables for said user selected equation; and
displaying said values, and units where applicable, of said one or more unknown variables.

12. The method of claim 11, further comprising:
displaying a list of sub-topics corresponding to a user selected topic;
displaying a prompt for a known variable for said user selected equation; and
displaying a calculation process with unit analysis.

13. The method of claim 11, further comprising:
displaying one or more menu tabs corresponding to one or more items selected from the group consisting of: periodic table, problem topic chemistry, problem, equation, solve, operation, problem topic physics, math calculator, math calculator, graph, and general idea;
accepting a user selection of a menu tab; and
displaying a pull down menu including one or more sub-menu choices.

14. The method of claim 13, wherein the description of a menu tab and the sub-menu choices corresponding to said menu tab are adapted according to inputs from previous steps in solving a problem.

15. The method of claim 13, further comprising:
highlighting a menu tab in response to a previous user input in a previous step.

16. The method of claim 11, characterized in that one or more steps of the method are carried out on a handheld computing device.

17. The method of claim 11, characterized in that the method is carried out on a network system including at least a user computing device, a network, and a server computer.

18. The method of claim 11, further comprising displaying a graph of said user selected equation.

19. One or more non-transitory computer readable media having processor readable program code embodied on at least one of said non-transitory computer readable media, said program code programming at least one processor to perform a method of chemistry and physics calculation, comprising:
displaying a list of topics, said topics including one or more items selected from the group consisting of: balancing equations, stoichiometry, gas laws, equilibrium, dimension analysis, electrochemistry, electricity, Newton laws, thermodynamics, properties of matter, mirrors and lenses, Ohm's law, Kirchhoff's Law, SI unit table, definition table, area & volume of objects, and density;
accepting a user topic selection;
displaying a list of one or more equations related to said user topic selection, each of said equations including more than one variables;
accepting a user selection of a user selected equation from said list of equations;
optionally accepting a user designation of one or more unknown variables for said user selected equation;
accepting user input of one or more values, and units where applicable, for one or more known variables for said user selected equation;
calculating values, and units where applicable, of said one or more unknown variables; and
displaying said values, and units where applicable, of one or more unknown variables.

20. The non-transitory computer readable media of claim 19, wherein said method of chemistry and physics calculation further comprises:
displaying a list of sub-topics corresponding to a user selected topic;
displaying a prompt for a known variable for said user selected equation; and
displaying a calculation process with unit analysis.

21. The non-transitory computer readable media of claim 19, wherein said method of chemistry and physics calculation further comprises:
displaying one or more menu tabs corresponding to one or more items selected from the group consisting of: periodic table, problem topic chemistry, problem, equation, solve, operation, problem topic physics, math calculator, math calculator, graph, and general idea;
accepting a user selection of a user selected menu tab;
displaying a description and an indicator of said user selected menu tab, indicating that said user selected menu tab is selected; and
displaying a pull down menu including one or more sub-menu choices, each of which can be selected by the user.

22. The non-transitory computer readable media of claim 21, wherein the description of a menu tab and the sub-menu choices corresponding to said menu tab are adapted according to inputs from previous steps in solving a problem.

23. The non-transitory computer readable media of claim 21, wherein said method of chemistry and physics calculation further comprises highlighting a menu tab in response to a previous user input in a previous step.

24. The non-transitory computer readable media of claim 19, further comprising processor readable program code for the processor to perform the additional method steps of: displaying a graph corresponding to said user selected equation; and tracing at least one curve on said graph.
